(19) United States
(12) Patent Application Publication
(10) Pub. No.: US 2018/0075174 A1
(43) Pub. Date: Mar. 15, 2018

(54) Methods for Real-Time Power Analysis in System Simulation

(71) Applicants: NINAD HUILGOL, FREMONT, CA (US); CESAR QUIROZ, SANTA CLARA, CA (US)

(72) Inventors: NINAD HUILGOL, FREMONT, CA (US); CESAR QUIROZ, SANTA CLARA, CA (US)

(21) Appl. No.: 15/263,352

(22) Filed: Sep. 12, 2016

(51) Int. Cl. G06F 17/50; G06F 3/0484

(52) U.S. Cl. CPC G06F 17/5009; G06F 3/04842

(57) ABSTRACT

A system simulation runs in addition to a standard simulator a power estimation block which uses the instrumented representation of the system and live data from the standard simulator to compute power consumption and then to display this on a GUI.

### PRIORITY

This application claims the priority of PPA 62/220,713.

### FIELD OF INVENTION

This pertains to the field of power estimation in the field of system-level simulation in engineering.

### BACKGROUND

Today before building many kinds of systems in it is quite important to simulate such a system to determine how much power it will consume.

The faster and earlier the designers simulate a system the better off they are. If possible it would be optimal for designers to see how much power a system produces dynamically as they design it. This is of course impossible, since at the point of design the designers do not know what stimuli the system will experience, and systemic power consumption varies with stimuli.

But the next best thing would be for the designers to determine power consumption dynamically, as a system runs simulation with stimulus vectors. This would provide power consumption data in real time to the designers as they simulate the system.

### PRIOR ART

Current methods to estimate power in systems rely upon a method that requires a simulation to be performed as a first step, which then produces a simulation results database. A power estimation tool then processes this data after the simulation has finished, producing a power consumption profile. Often, the simulations can be very long, and the wait to get all simulation data produced results in an inefficient work flow.

### SUMMARY OF THE INVENTION

The present invention teaches methods to perform system-level estimation of power consumption through simulation. As the computer simulation of a system progresses methods track how much power different parts of the system consume incrementally. The simulation displays these results graphically to the designers in real-time, and also saves the results. The simulation may also display in real-time how the current results track against one or more sets of historic results.

### BRIEF DESCRIPTION OF THE DRAWINGS

FIG. 1 shows an embodiment of the invention. Here the design (101) is instrumented by software programs instrumentation and/or synthesis (102) into an instrumented design (103). The simulator (105) reads in both the design (101) and input vectors (104) to produce live streaming data (106). The Power Estimation block (107) reads in 103 and 106 to produce live power estimation data (109). 109 gets sent both to other programs (111) and to be stored in the file system (112). 107 also potentially sends commands (108) to 105. 107 also sends displays of 109 to a GUI (111). 107 also reads back prior power estimation data (110) from 109 to compare against current live data (106), and displays this also to 111 if this is specified.

### EMBODIMENTS

### Definitions

A software object is a coherent set of software methods and data intended to work on particular input data to perform a particular set of methods which transform those input data in specific ways. Software objects may contain other software objects to form a hierarchical structure. The methods in a software object may be organized as associated with particular input data. The software object may keep persistent data both as user-specified parameters, and as computed data which it derives from input data in some way, one example of this being statistics.

### Core Functionality of the Invention

In an embodiment to perform the power analysis on live streaming simulation data, one uses a method which comprises the following steps:
1. Synthesize the system design on which to do power analysis, i.e. instrument the design to understand underlying unit structures. Existing synthesis tools do this. Store the instrumented design (ID) in a computer storage medium for reference later.
2. Simulate the design using an existing simulator. The invention is independent of the type of simulator, or the type of simulation data that the simulator produces.

In an embodiment this simulation runs parallel both the existing simulator and a power analysis and estimation block PE. PE is a software object intended to estimate dynamically the power a simulated system consumes.

In an embodiment PE provides to the designers the ability to control it through at least one of the following means:
a Graphical User Interface (GUI)
a command line interface (CLI)
a script
an API to allow other programs to invoke methods

These means are called the user control interface (UCI).

In some embodiments PE is adapted the simulator's API to perform the following actions:
start system simulation
end system simulation
pause system simulation
progress system simulation for some number of steps
progress system simulation for some duration of simulation time

In some further embodiments PE is adapted to provide the user the capability to invoke these actions through the UCI.

In some embodiments PE reads ID before simulation starts. In some embodiments PE reads ID when simulation starts. In some embodiments PE reads ID as it is needed. In some embodiments PE reads ID all at the same time. In some embodiments PE reads some part of ID at a time.

In an embodiment when the simulation runs the simulator sends live streaming data (LSD) to PE. In some embodiments PE also sends LSD to other processes. In some embodiments the PE block also writes LSD to a file.

In embodiments where PE outputs data to files or other blocks:
In some such embodiments PE outputs such data some specific number of times.
In some such embodiments PE outputs such data multiple times.
In some such embodiments PE outputs such data consequent of a plurality of events.
In some such embodiments PE outputs such data continually as it creates such data.
In some such embodiments PE outputs such data as a combination of these other considerations.

In an embodiment PE uses methods to transform ID and the received LSD into real-time or “live” power profile data (PPD). PPD shows how the simulated system consumes power.

In some embodiments PE sends PPD to the GUI, which displays a history of PPD up to the current PPD.

This method then allows users to determine the power consumption of their system in real time, pause or stop simulation at will, change their system design to make improvements, and re-run the simulations to see the effects.

### Enhancement—Pausing

In some embodiments PE provides the designers through the UCI the ability to pause or to stop simulation based on criteria. In some further embodiments these criteria include:
reaching a limit of power consumption

If the designers specify such a limit through the UCI then when this limit is reached the PE uses the simulator's API to pause or to stop simulation, as specified.

This allows users to conveniently pause or stop the fast, live streaming simulation in order to understand a power consumption issue better.

### Enhancement—Comparison

In some embodiments PE provides through the UCI the ability to invoke a method to compare current LSD with one stored previously. In some further embodiments the PE displays this in a GUI. with that of a previously stored simulation result.

To performs this: When PE receives LSD it also saves that LSD to a file, as described above.

In some embodiments PE reads a stored LSD and dynamically compares it to current LSD from the live simulation currently running, comparing them in a GUI.

In some embodiments PE reads two stored LSDs and compares them in a GUI. This is called historical comparison.

In any such case the PE plots power consumption versus time for both LSDs. The user chooses to show the raw values of LSD, or a deviation such as a division of two LSD values.

By plotting these axes in the graph, users can then see ‘deviation’ from their previous iterations when X and Y axes contain power estimation data. The users can also see power analysis or estimation in real time, when X axis contains time units.

The comparison is done to aid real-time or ‘live’ debugging of system power consumption. Using this live streaming analysis mode for power estimation and analysis, the users can perform ‘power debug’ of their systems faster, using less human resources and with more efficiency.

### Example Embodiment

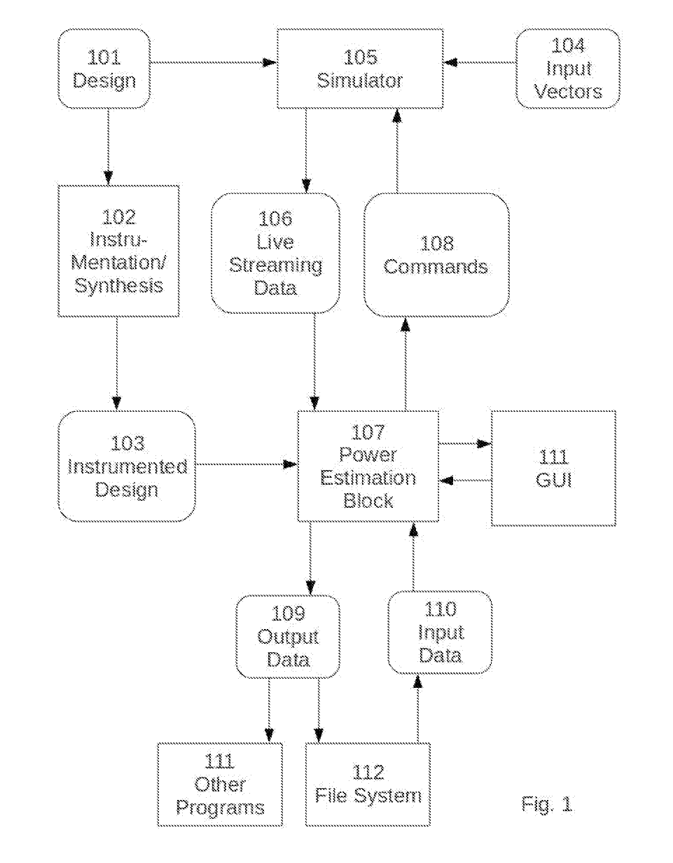

In the embodiment shown in FIG. 1 a design (101) first feeds into the instrumentation and synthesis programs (102) which generates an instrumented design (103). After this happens the simulator (105) and power estimation block (107) start together. When it starts the power estimation block reads in the instrumented design. Also, the simulator reads in the design (101) and the input vectors (104). While the simulator runs it produces live streaming data (106) which feeds into the power estimation block. The power estimation block interacts with a GUI (111) to display the live power, and also to read in commands. Some of these commands include commands to the simulator, and in such cases the power estimation block sends those commands (108) onto the simulator. The power estimation block also saves its output data (109) to the file system (112) as a file, and also sends it to other programs (111). In the case of a comparison the power estimation block reads historic data (110) from the file system for comparison against the live streaming data.

### Conclusions, Ramifications and Scope

We show these embodiments of the invention to be exemplary and not in any way limiting. Many other embodiments are possible, without departing from the spirit of the invention or sacrificing its advantages.

The invention presented here will shorten and cheapen the design cycle time for systemic development where power consumption is a consideration, since the designers may view in real time how much power their systems consume, and thus change those designs to eliminate inefficiencies as early as possible. This will save both time and money.

We claim:

1. A method for simulating a system on a computer which comprises the following steps:
a) the designers first synthesize or instrument the system, resulting in a instrumented design;
b) simulation runs a simulator in parallel with a power estimation block;
where during simulation:
c) said power estimation block reads in pertinent data from said instrumented design before or when said pertinent data is needed;
d) said simulator feeds live streaming data to said power estimation block;
e) said power estimation block combines information from said instrumented design and said power estimation block to produce real-time power consumption data;
thereby allowing the designers to understand power consumption dynamically as the system simulates.

2. The method of claim 1 comprising a step where said power estimation block sends said live streaming data to another process.

3. The method of claim 1 comprising a step where said power estimation block sends said live stream data to a stored filed.

4. The method of claim 1 comprising steps to allow the designers to view said power consumption data in a GUI.

5. The method of claim 4 comprising steps:
a) to read historic data from a stored file;
b) to compare said historic data against current live streaming data;
c) to display said results.

6. The method of claim 2 comprising a step to allow the designers to command said power estimation block to command said simulator to take an action drawn from the following set:
a) start simulation;
b) pause simulation;
c) stop simulation;
d) progress simulation for some number of steps;
e) progress simulation for some amount of simulation time.

7. The method of claim 5 comprising a step to allow the designers to command said simulator to take an action drawn from the following set:
a) pause simulation;
b) stop simulation;
based on meeting some criterion.
